(19) United States
(12) Patent Application Publication
(10) Pub. No.: US 2008/0166630 A1
(43) Pub. Date: Jul. 10, 2008

(54) Sealed Battery, Method For Producing the Same, Assembled Battery Comprising a Plurality of Sealed Batteries

(75) Inventors: Kazuya Okabe, Kyoto (JP); Satoshi Yokota, Kyoto (JP); Takahiro Itagaki, Kyoto (JP); Tomonori Kishimoto, Kyoto (JP); Shuichi Izuchi, Kyoto (JP)

Correspondence Address: KANESAKA BERNER AND PARTNERS LLP, 1700 DIAGONAL RD, SUITE 310, ALEXANDRIA, VA, 22314-2848, US

(73) Assignee: GS YUASA CORPORATION, Kyoto-shi (JP)

(21) Appl. No.: 11/791,742

(22) PCT Filed: Nov. 28, 2005
(86) PCT No.: PCT/JP05/22222

§ 371 Date: May 29, 2007

(30) Foreign Application Priority Data
Nov. 30, 2004 (JP) 2004-345151

(51) Int. Cl. H01M 2/30; H01M 2/08; H01M 6/00

(52) U.S. Cl. 429/178; 429/185; 29/623.2

(57) ABSTRACT

An object of the invention is to provide a sealed battery having a low resistance, excellent in the output power, and provided with a current collecting structure by setting welding points of a lower current collecting plate and a container bottom surface at specified positions without requiring a current collecting substrate with a special structure or a complicated welding method.

The invention provides a sealed battery obtained by housing an electrode assembly (70) including a positive electrode plate and a negative electrode plate in a container (60), arranging an upper current collecting plate (2) on the electrode assembly (70), welding the upper surface of the upper current collecting plate (2) electrically connected with one of the electrodes of the electrode assembly (70) with the inner surface of a lid (50) through a lead (20, 30), using a safety valve formed by putting a cap (80) on the upper part of the center of a bare lid through a valve body (90) as the lid (50), arranging a lower current collecting plate (100) under the electrode assembly (70), and welding the lower surface of the lower current collecting plate (100) electrically connected with the other electrode of the electrode assembly (70) with the inner surface of the container (60) bottom and characterized in that welding points (100-1) of the lower surface of the lower current collecting plate (100) and the inner surface of the container (60) bottom are at least outside of positions (101) of the lower current collecting plate corresponding to immediately under the end part of the cap (80). The welding points (100-1) are at positions within a range between a concentric circle parted from the center by 48% and a concentric circle parted from the center by 93% in the length from the center to the outer circumference of the lower current collecting plate (100).

### TECHNICAL FIELD

The present invention relates to a sealed battery, a method for producing the same, and an assembled battery including a plurality of sealed batteries, and particularly to improvement of the structure for connecting a current collecting plate of a sealed battery and a bottom of a container.

### BACKGROUND ART

In general, an alkaline battery such as a nickel metal-hydride battery and a nickel-cadmium battery is composed by housing a power generating element in a battery case and using the battery case as one terminal.

In particular, in the case of using such an alkaline battery for charging and discharging at high power for an electric tool, an electric vehicle, or the like, the electric resistance of a current collecting substrate which connects between a power generating element and the bottom of a battery case (container bottom) affects battery properties of the battery.

Conventionally, with respect to the current collecting structure of the battery to be used for these uses, each one of rectangular or approximately disc-like current collecting substrate is welded at a plurality of points in the edges of electrode plates outward jutted from the upper and lower end faces of an electrode assembly, respectively, and a case and a negative electrode current collecting substrate are welded at one point in the center bottom part of the case by a welding electrode having a diameter of about 3 mm and inserted into a through hole of the center part of the current collecting substrate and a welding electrode disposed in the case bottom part (e.g., reference to Patent Document 1).

Patent Document 1: Japanese Patent Application Laid-Open (JP-A) No. 11-31497.

Since the above-mentioned case and the negative electrode current collecting substrate are welded only at one point, the connection resistance of the case and the current collecting substrate is high and if discharge is carried out at electric current as high as 100 A, since, for example, the resistance of the welded part of the case and the negative electrode current collecting substrate is high, the voltage of the battery is sharply decreased. To solve this problem, batteries with lowered inner resistance has been developed (reference to Patent Document 2)

Patent Document 2: JP-A No. 2004-55371

A battery described in Patent Document 2 is as follows: a cylindrical battery comprising a windingly rolled electrode assembly of a positive electrode, a negative electrode, and a separator formed in a manner that the tip end part of a core material of said positive electrode plate is jutted upward and the tip end part of the core material of said negative electrode plate is jutted downward, a negative electrode current collecting substrate welded to the downward jutted part of the core material, a metal case working as an inlet/outlet terminal of the negative electrode and housing the electrode assembly and the current collecting substrate, and a sealing body equipped with a cap in the upper side also having a function as an inlet/outlet terminal of the positive electrode and electrically insulated from the case for sealing the case; wherein said negative electrode current collecting substrate has a cylindrical shape with a bottom and composed of a bottom surface part connected with the downward jutted part of the core material and a cylindrical part connected with the case (claim 1): the cylindrical battery according o claim 1, wherein the cylindrical part of the negative electrode current collecting substrate has at least 2 projected parts for projection welding and the projected parts are welded with the case (claim 3): and the cylindrical battery according to claim 1, wherein the flat face part of the negative electrode current collecting substrate and the case are connected (claim 4).

In the structure of this cylindrical battery, the following effect is provided, that is, “since the negative electrode current collecting substrate having the cylindrical shape with a bottom and the case are welded at 2 or more points, the inner resistance of the battery can be lowered and charge and discharge of the battery can be carried out at a high efficiency” (paragraph [0017]), however, it is required to make the negative electrode current collecting substrate have a special structure having a cylindrical part but not a plate-like shape and accordingly it is made difficult to form a large number of welding points.

Further, the following invention has been known as an invention relevant to a battery whose inner resistance is lowed by improving the connection means of the current collecting substrate and the bottom part of the case (reference to Patent Document 3).

Patent Document 3: JP-A No. 2000-58024

A method for producing a battery described in Patent Document 3 is as follows: a method for producing a cylindrical battery including an electrode unit obtained by rolling a positive electrode plate, a negative electrode plate, and a separator sandwiched between both electrodes in a state that the center is made hollow, a case having a bottom and capable of housing the electrode unit, and a current collecting substrate attached to the end face of said electrode unit and connected to one of the electrode plate and welded in the bottom part of said case; wherein the method is characterized in that the hollow center part of the electrode unit is made suitable to insert a spot welding electrode for welding said current collecting substrate and said case into and a welded part is formed at a position eccentric to the axis of the electrode unit main body in the tip end of the electrode and primary welding is carried out while said current collecting substrate is sandwiched between the welding part and the bottom part of said case and successively the spot welding electrode is rotated and secondary welding is carried out while said current collecting substrate is sandwiched between the welded part and the case (claim 3).

According to the method for producing a cylindrical battery, the method is characterized as follows: “since the welded part of the spot welding electrode is formed at a position eccentric to the axis of the electrode unit main body, after the primary welding, the secondary welding can be carried out while the position of the welded part is changed by rotating the spot welding electrode at a prescribed angle from the welded point of the primary welding. Accordingly, welding can be carried out at two points and therefore, the contact reliability of the current collecting substrate and the case can be improved. Further, as compared with the case of welding at one point, current concentration can be prevented and occurrence of resistance loss can be suppressed.” (paragraph [0011]): and “the above-mentioned embodiment shows the case of welding at two points, however the case of welding at three points or more is within the scope of the invention.” (paragraph [0033]); however the welding method is complicated and there is a problem that it is difficult to carry out welding at three or more points.

### DISCLOSURE OF THE INVENTION

### Problems to be Solved by the Invention

To solve the above-mentioned problems, the invention aims to provide a sealed battery having a low resistance, excellent in the output power, and provided with a current collecting structure by setting welding points of a lower current collecting plate and a container bottom surface at specified positions without requiring a current collecting substrate with special structure or a complicated welding method.

### Means for Solving the Problems

The invention employs the following means for solving the above-mentioned problems: that is,

(1) the invention provides a sealed battery obtained by housing an electrode assembly including a positive electrode plate and a negative electrode plate in a container, arranging an upper current collecting plate on the electrode assembly, welding the upper surface of the upper current collecting plate electrically connected with one of the electrodes of the electrode assembly with the inner surface of a lid through a lead, using a safety valve formed by putting a cap on the center upper part of a bare lid through a valve body as the lid, arranging a lower current collecting plate under the electrode assembly, and welding the lower surface of the lower current collecting plate electrically connected with the other electrode of the electrode assembly with the inner surface of the container bottom and characterized in that welding portions of the lower surface of the lower current collecting plate and the inner surface of the container bottom are at least outside of positions of the lower current collecting plate corresponding to immediately under the end part of the cap:

(2) the sealed battery according to the description (1), in which the welding portions of the lower surface of the lower current collecting plate and the inner surface of the container bottom are at one point of the center part of the lower current collecting plate and 4 to 16 points outside of positions of the lower current collecting plate corresponding to immediately under the end part of the cap:

(3) a sealed battery obtained by housing an electrode assembly including a positive electrode plate and a negative electrode plate in a container, arranging an upper current collecting plate on the electrode assembly, welding the upper surface of the upper current collecting plate electrically connected with one of the electrodes of the electrode assembly with the inner surface of a lid through a lead, arranging a lower current collecting plate under the electrode assembly, and welding the lower surface of the lower current collecting plate electrically connected with the other electrode of the electrode assembly with the inner surface of the container bottom and characterized in that welding portions of the lower surface of the lower current collecting plate and the inner surface of the container bottom are within a range between a concentric circle parted from the center by 48% and a concentric circle parted from the center by 93% in the length from the center to the outer circumference of the lower current collecting plate:

(4) the sealed battery according to the description (3), in which the welding portions of the lower surface of the lower current collecting plate and the inner surface of the container bottom are at least within a range between a concentric circle parted from the center by 48% and a concentric circle parted from the center by 76% in the length from the center to the outer circumference of the lower current collecting plate:

(5) the sealed battery according to the description (3), in which the welding portions of the lower surface of the lower current collecting plate and the inner surface of the container bottom are at one point of the center part of the lower current collecting plate and 4 to 16 points within a range between a concentric circle parted from the center by 48% and a concentric circle parted from the center by 93% in the length from the center to the outer circumference of the lower current collecting plate:

(6) the sealed battery according to the description (4), in which the welding portions of the lower surface of the lower current collecting plate and the inner surface of the container bottom are at one point of the center part of the lower current collecting plate and 4 to 16 points within a range between a concentric circle parted from the center by 48% and a concentric circle parted from the center by 76% in the length from the center to the outer circumference of the lower current collecting plate:

(7) the sealed battery according to one of the descriptions (3) to (6), in which the welding points of the lead in the upper surface of the upper current collecting plate is within a range between a concentric circle parted from the center by 48% and a concentric circle parted from the center by 93% in the length from the center to the outer circumference of the upper current collecting plate:

(8) a method for producing a sealed battery as described in the description (1) or (2), in which the method comprises a first step of carrying out welding at welding points outside of positions of the lower current collecting plate corresponding to immediately under the end part of the cap and a second step of carrying out welding at one point in the center part of the lower current collecting plate:

(9) the method for producing a sealed battery according to the description (8), in which a welding method of the first step of carrying out welding at welding points outside of positions of the lower current collecting plate corresponding to immediately under the end part of the cap is performed by applying alternating current pulses in sets of charging and discharging between the upper current collecting plate (an outside positive electrode terminal before assembly of the battery) and the negative electrode terminal using an outside electric power after an electrolyte solution is injected to the electrode assembly:

(10) a method for producing a sealed battery as described in one of the descriptions (3) to (7), in which the method comprises a first step of carrying out welding at welding points within a range between a concentric circle parted from the center by 48% and a concentric circle parted from the center by 93% in the length from the center to the outer circumference of the lower current collecting plate and a second step of carrying out welding at one point in the center part of the lower current collecting plate.

(11) the method for producing a sealed battery according to the description (10), in which a welding method of the first step of carrying out welding at welding points within a range between a concentric circle parted from the center by 48% and a concentric circle parted from the center by 93% in the length from the center to the outer circumference of the lower current collecting plate is performed by applying alternating current pulses in sets of charging and discharging between the upper current collecting plate (an outside positive electrode terminal before assembly of the battery) and the negative electrode terminal using an outside electric power after an electrolyte solution is injected to the electrode assembly:

(12) the method for producing a sealed battery as described in one of the descriptions (8) to (11), in which a welding method of the second step of carrying out welding at one point in the center part of the lower current collecting plate is performed by pushing electrode rods for resistance welding to the upper surface of the lower current collecting plate and the outer surface of the container bottom for carrying out resistance welding of the lower surface of the lower current collecting plate and the inner surface of the container bottom:

(13) an assembled battery including a plurality of sealed batteries as described in one of the descriptions (1) to (7):

(14) an assembled battery according to the description (13), in which the upper surface of the lid of one sealed battery and the outer surface of the container bottom of another sealed battery are connected through a cell-to-cell connector and the welding points of the cell-to-cell connector and the upper surface of the lid are outside of positions of the end part of the cap and the welding points of the cell-to-cell connector and the outer surface of the container bottom are outside of the positions of the outer surface of the container bottom corresponding to immediately above the end part of the cap:

(15) the assembled battery according to the description (13) or (14), in which the welding points of the cell-to-cell connector and the upper surface of the upper surface of the lid are adjusted to be coincident with the welding points of the lead in the inner surface of the lid in a range outside of the end part of the cap.

### EFFECT OF THE INVENTION

In the invention, the welding points of the lower current collecting plate and the container bottom surface are positioned at certain points, so that it is made possible to provide a battery with a low inner resistance and a high output power.

Further, it is made possible to give output density extremely high and 1400 W/kg or higher, which could be accomplished only by a costly and square shape nickel metal-hydride battery with a particular structure, to a cylindrical battery.

### BRIEF DESCRIPTION OF THE DRAWINGS

FIG. 1 is a drawing of a sealed battery of Examples and Comparative Examples in which leads including a main lead and a supplementary lead are welded.

FIG. 2A is a drawing showing an upper current collecting plate (a positive electrode current collecting plate) (four slits) employed for the invention.

FIG. 2B is a drawing showing an upper current collecting plate (a positive electrode current collecting plate) (eight slits) employed for the invention.

FIG. 3A is a drawing showing a lower current collecting plate (a negative electrode current collecting plate) (four slits) employed for Examples 1 to 3 and Comparative Example 1.

FIG. 3B is a drawing showing an upper current collecting plate (a positive electrode current collecting plate) (eight slits) employed for Examples 4 to 13 and Comparative Examples 2 to 7.

FIG. 4 is a drawing showing projected parts (four points) to be welding points with the container bottom formed in the lower surface of the negative electrode current collecting plate of Example 1.

FIG. 5 is a drawing showing projected parts (eight points) to be welding points with the container bottom formed in the lower surface of the negative electrode current collecting plate of Example 5.

FIG. 6 is a drawing showing projected parts (sixteen points) to be welding points with the container bottom formed in the lower surface of the negative electrode current collecting plate of Examples 6 to 13.

FIG. 7 is a drawing showing projected parts (two points) to be welding points with the container bottom formed in the lower surface of the negative electrode current collecting plate of Comparative Example 3.

FIG. 8 is a drawing showing assembly of a sealed battery in which a ring-shape main lead is welded via a supplementary lead.

FIG. 9 is a drawing showing an assembled battery using sealed batteries of the invention.

### EXPLANATION OF REFERENCE NUMERAL

60 a container
70 an electrode assembly
50 a lid
90 a valve body
80 a cap
51 a position in the inner surface of a lid corresponding to the end part of a cap
2 an upper current collecting plate (a positive electrode current collecting plate)
2-2 slits formed in an upper current collecting plate
2-3 ridges formed in an upper current collecting plate
20 a ring-shaped lead (a main lead)
30 a supplementary lead
100 a lower current collecting plate (a negative electrode current collecting plate)
101 a position of a lower current collecting plate corresponding to immediately under the end part of a cap
100-1 projected parts (existing in a range between a concentric circle parted from the center by 48% and a concentric circle parted from the center by 93% in the length from the center to the outer circumference of the lower current collecting plate) to be points at which a container bottom is welded in a lower surface of a lower current collecting plate
100-2 projected parts formed in the center part of the lower surface of a lower current collecting plate to be welding points with a container bottom
100-3 slits formed in a lower current collecting plate
100-4 ridges formed in a lower current collecting plate
110 cell-to-cell connector

### BEST MODE FOR CARRYING OUT THE INVENTION

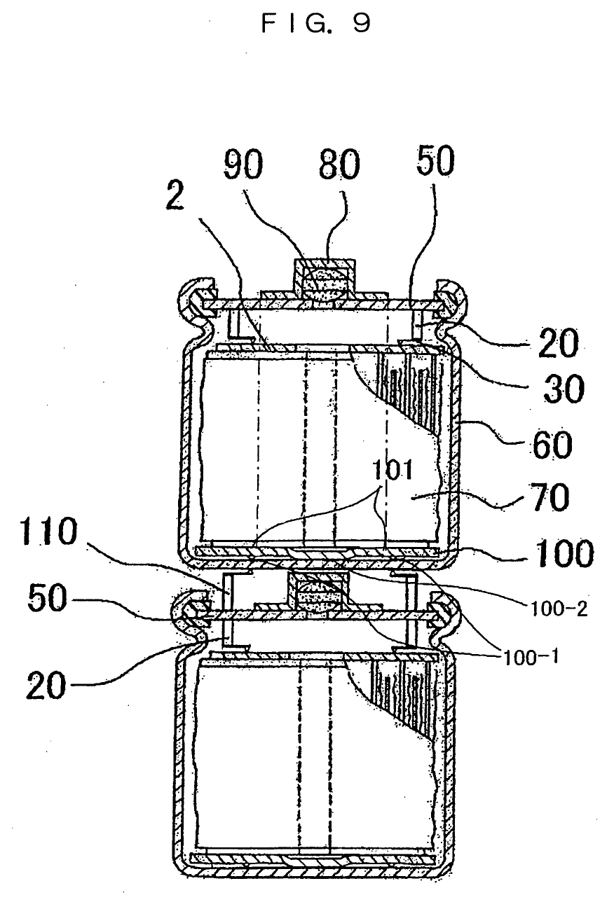

In a sealed battery, since, at welding portions of the lower surface of a lower current collecting plate (a negative electrode current collecting plate) and one point of the center in the inner surface of the container bottom, resistance welding can be carried out by inserting a welding rod into the center of the electrode assembly without applying electric current to the battery, strong welding having an extremely low resistance can be carried out. However, in the case of an assembled battery, as shown in FIG. 9, a cell-to-cell connector 110 is welded outside of the end part of the cap 80 attached to a lid 50 of one battery and the outer surface of the bottom of a container 60 of another battery is welded via the cell-to-cell connector and the shortest distance of the welding points in the outer surface of the bottom of the container 60 is outside of the position of the lower current collecting plate 100 corresponding to immediately under the end part of the cap 80, so that the path of electric current is a path of the welding point of the cell-to-cell connector and the outer surface of the container bottom, the welding point of the inner surface of the container bottom and the lower current collecting plate (one point in the center part), and the welding point of the lower current collecting plate and negative electrode plate in this order, and thus becomes long to increase the resistance.

Therefore, in the invention, the welding point of the lower surface of the lower current collecting plate 100 and the inner surface of the bottom of the container 60 is one point in the center part but is formed outside of a position 101 of the lower surface of the lower current collecting plate 100 corresponding to immediately under the end part of the cap, so that the path of the electric current can be shortened for reducing the inner resistance.

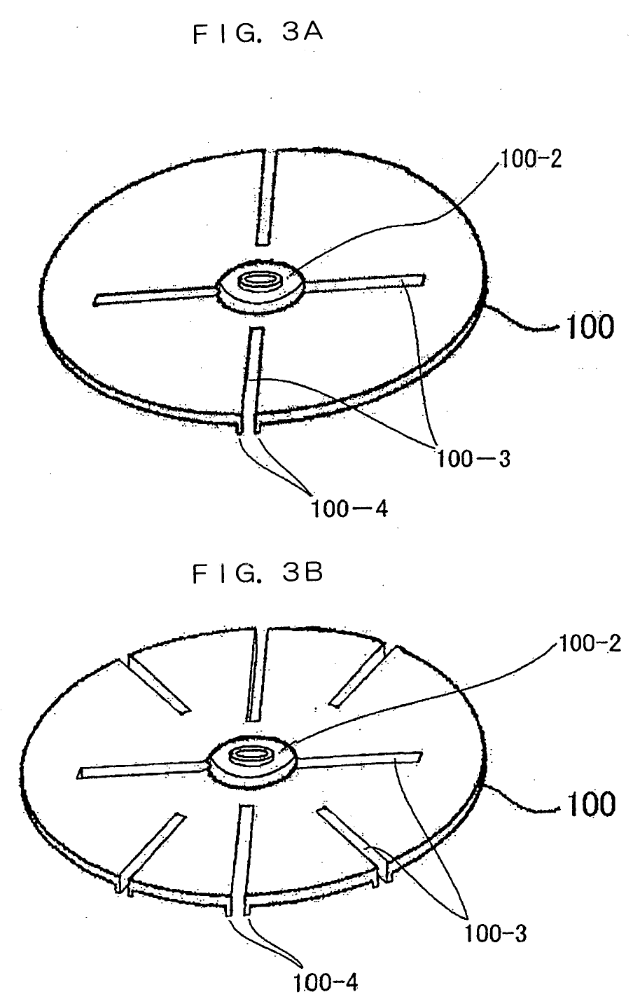

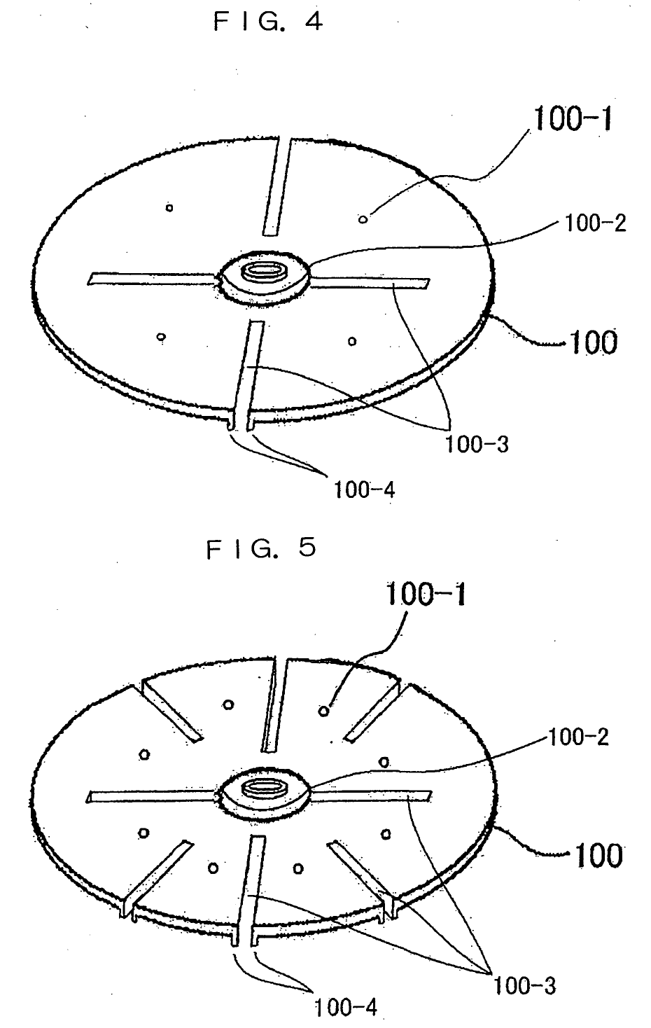

FIG. 3 to FIG. 7 show a drawing of the lower current collecting plate 100 to be employed for the sealed battery of the invention (FIGS. 3A and 3B do not show projected parts 100-1 for welding). The lower current collecting plate 100 is made of a nickel-plated steel plate and has a disk-like shape with a thickness of 0.3 to 0.5 mm. As shown in FIG. 3 to FIG. 7, the lower current collecting plate 100 is provided with a projected part 100-2 for welding in the center (in the drawings, a ring-like projection is formed in the projected part). Further, a plurality of slits 100-3 are formed at equal intervals (in FIG. 3A and FIG. 4, there are 4 slits and in FIG. 3B and FIGS. 5 to 7, there are 8 slits) and ridges 100-4 with a height of about 0.5 mm are arranged in the sides of the slits. The ridges 100-4 bit the substrate when the lower current collecting plate 100 is welded with the negative electrode plate to accomplish good joining. The number of the slits 100-3 is not particularly limited, however it is more preferably 8 than 4 since the welding points density of the lower current collecting plate and the negative electrode plate becomes higher and the current collecting function of the negative electrode plate is increased more and accordingly the inner resistance of the battery can be lowered.

As shown in Examples described below, if the welding portions of the lower surface of the lower current collecting plate and the inner surface of the container bottom are at least within a range between a concentric circle parted from the center by 48% and a concentric circle parted from the center by 93% in the length from the center to the outer circumference of the lower current collecting plate, the inner resistance is lowered and the output density is increased. In particular, it is more preferable that the welding points are within a range between a concentric circle parted from the center by 48% and a concentric circle parted from the center by 76% in the length from the center to the outer circumference of the lower current collecting plate, since the effect is more significant.

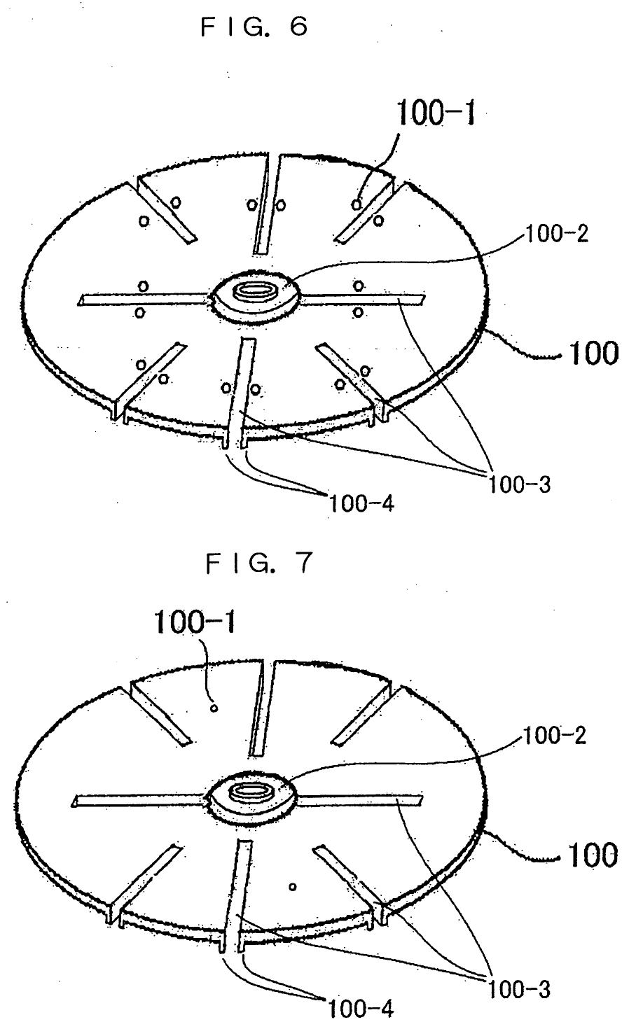

As shown in FIG. 6, if the welding point (projected part 100-1 for welding) is positioned adjacently to the ridge parts 100-4, the electric resistance between the negative electrode plate and the inner surface of the container bottom can be lowered and thus it is preferable.

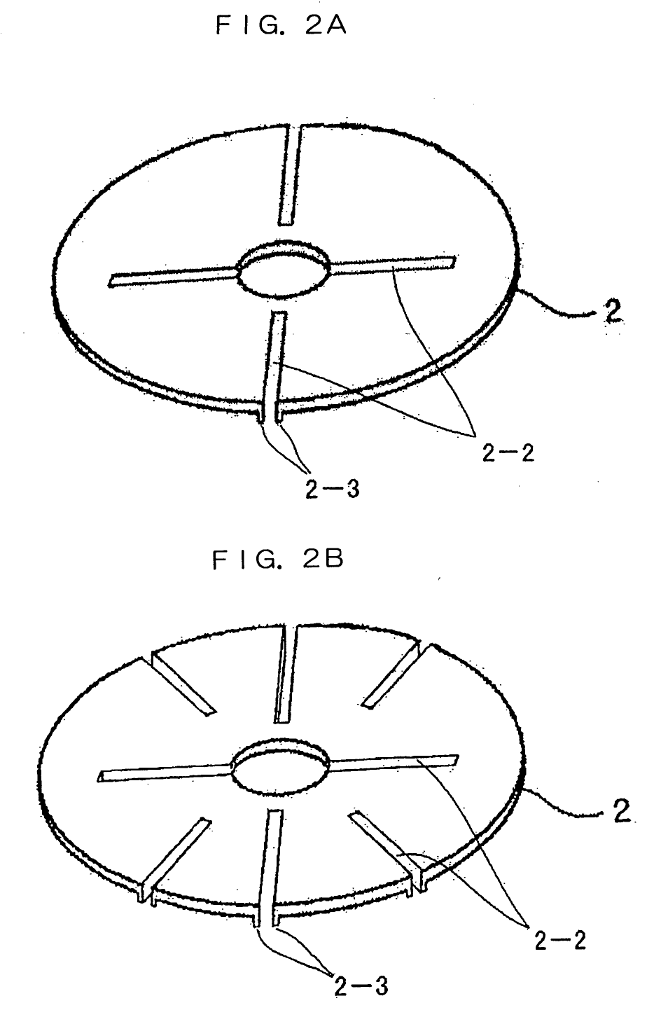

FIGS. 2A and 2B are drawings showing the upper current collecting plate to be employed for the sealed battery of the invention. The upper current collecting plate 2 is made of a nickel-plated steel plate and has a disk-like shape with a thickness of 0.3 to 0.5 mm. As shown in FIGS. 2A and 2B, the upper current collecting plate 2 is provided with a plurality of slits 2-2 at equal intervals (in FIG. 2A, there are 4 slits and in FIG. 2B, there are 8 slits) and ridges 2-3 with a height of about 0.5 mm are arranged in the sides of the slits. When the upper current collecting plate 2 is welded with the positive electrode plate, the ridges 2-3 bit the substrate to accomplish good joining. The number of the slits 2-2 is not particularly limited, however it is more preferably 8 than 4 since the welding points density of the upper current collecting plate and the negative electrode plate becomes higher and the current collecting function of the positive electrode plate is increased more and accordingly the inner resistance of the battery can be lowered.

As described above, the welding portions of the lower surface of the lower current collecting plate and the inner surface of the container bottom are adjusted within a specified range and at the same time, also the welding points of lead in the upper surface of the upper current collecting plate are within a range between a concentric circle parted from the center by 48% and a concentric circle parted from the center by 93% in the length from the center to the outer circumference of the upper current collecting plate and accordingly, the path of the electric current can shorten and the inner resistance can be lowered.

If the welding points are positioned adjacently to the ridge parts 2-3, the electric resistance between the positive electrode plate and the lead can be lowered and accordingly, it is preferable.

In the invention, if a large number of the welding points of the lower surface of the lower current collecting plate and the inner surface of the container bottom are formed, the inner resistance can be lowered and the output density can be increased. As shown in Examples below, the welding points are preferably 4 to 16 points outside of the position of the lower surface of the lower current collecting plate corresponding to immediately under the end part of the cap or with in a range between a concentric circle parted from the center by 48% and a concentric circle parted from the center by 93% in the length from the center to the outer circumference of the lower current collecting plate.

A plurality of the welding points are not necessarily required to exist on a single concentric circle if they are within the above-mentioned range.

The welded position of one point in the center of the lower current collecting plate and the container bottom can be formed by resistance welding by inserting a welding rod without applying electric current to the battery, so that it is preferable to form the point in combination.

In this case, the following steps may be employed: a first step of forming projected parts to be welding points with the container bottom outside of the lower surface of the lower current collecting plate corresponding to immediately under the end part of the cap or within a range between a concentric circle parted from the center by 48% and a concentric circle parted from the center by 93% in the length from the center to the outer circumference of the lower current collecting plate and a second step of carrying out welding at one point in the center part of the lower surface of the lower current collecting plate by pushing the electrode rod for resistance welding to the upper surface of the lower current collecting plate and the outer surface of the container bottom and closely sticking the projected part (100-2) formed in the center part of the lower surface of the lower current collecting plate and the inner surface of the container bottom.

At the time of welding for the welding points outside of the lower surface of the lower current collecting plate corresponding to immediately under the end part of the cap or within a range between a concentric circle parted from the center by 48% and a concentric circle parted from the center by 93% in the length from the center to the outer circumference of the lower current collecting plate after an electrolyte solution is poured to the electrode assembly, an alternating pulsed electric current which is high is applied to both positive and negative electrodes for an extremely short time. That is, alternating current pulses in sets of charging and discharging are applied between the upper current collecting plate (an outside positive electrode terminal before assembly of the battery) and the negative electrode terminal using an outside electric power. Since the applied electric power is stored in an electric double layer of the positive electrode plate and the negative electrode plate, the electrolyte solution can be prevented from decomposition by electrolysis. If the electric double layer capacity is high, the electric power at a high electric current to be applied without damaging the battery can be increased. The electric double layer capacity of the positive electrode plate and the negative electrode plate is supposed to be closely relevant to the charging capacity of the electrode plates, it is supposed to be preferable to properly set the current to be applied or the electric power quantity (converted into electric power application time if the electric current is constant) to be applied one time in one direction in relation to the capacity of the electrode plates. In this invention, the electric current to be applied per unit discharge capacity is set and then the duration of the electric power application time is determined, so that even if the current is applied between the positive and the negative electrodes, the lower surface of the lower current collecting plate and the inner surface of the container bottom can be excellently welded without damaging the battery.

Practically, the electric current to be applied per unit discharge capacity is adjusted to be 0.4 to 0.8 kA/Ah and the application duration is set to be 3 to 7 msec. In this connection, the discharge capacities of the positive electrode and the negative electrode of the battery are not necessarily equal and in the case of an alkaline secondary battery such as a nickel metal-hydride secondary battery and a nickel-cadmium battery, the discharge capacity of the positive electrode is smaller than that of the negative electrode. In such a case, the electric current to be applied per unit discharge capacity is set on the basis of the discharge capacity of the positive electrode, whose discharge capacity is smaller than the discharge capacity of the negative electrode. The intensity of the electric current to be applied is not necessarily constant for the time. Herein, the intensity of the electric current to be applied means the average value for the electric current applied for the electric current application time.

As described above, since the capacity of the electric double layer is high, even if a high electric current is applied between the positive and the negative electrodes, no electrolysis is caused and welding can be carried out excellently. For example, in the case of a nickel metal-hydride secondary battery, supposedly attributed to a low specific surface area of a hydrogen-storage alloy powder composing the negative electrode, the electric double layer capacity of the negative electrode plate tends to be smaller than that of the positive electrode plate. From that viewpoint, it is preferable to increase the electric double layer capacity of the negative electrode plate by immersing the hydrogen-storage alloy powder in an aqueous NaOH solution or an aqueous acetic acid-sodium acetate solution at a high temperature before the negative electrode plate is assembled in a battery. Further, the sealed secondary battery of the invention has a low inner resistance and is accordingly provided with suitability for quick charging. Therefore, it is preferable to make the positive electrode and the negative electrode have high chargeability.

For example, in the case of a nickel metal-hydride secondary battery, for the nickel electrode as the positive electrode, a mixture of nickel hydroxide with zinc hydroxide and cobalt hydroxide may be employed and a complex hydroxide containing nickel hydroxide as a main component and obtained by co-precipitation of nickel hydroxide with zinc hydroxide and cobalt hydroxide is more preferable. Further, it is more preferable to have such a composition that suppressed oxygen evolution on the nickel electrode when oxygen overpotential on the nickel electrode increases to carry out quick charge by adding a simple substance of rare earth elements such as Y, Er, and Yb or their compounds to the nickel electrode.

As described above, the sealed battery of the invention is effective in the case of forming an assembled battery. In the case of producing an assembled battery, as shown in FIG. 9, in the assembled battery obtained by connecting the upper surface of the lid (50) of one sealed battery to the outer surface of the bottom of the container (60) of another sealed battery via a cell-to-cell connector (110), it is preferable that the welding points of the cell-to-cell connector (110) and the upper surface of the lid (50) are outside of the end part of a cap (80) and that the welding points of the cell-to-cell connector (110) and the outer surface of the bottom of the container (60) outside of the position of the outer surface of the container bottom corresponding to immediately under the end part of the cap (80). Accordingly, it is made possible to obtain an assembled battery with a low resistance and high output power.

In the above-mentioned case, if, in the range outside of the end part of the cap (80), the positions of the welding points of the cell-to-cell connector (110) and the upper surface of the lid (50) match that of the welding points of the main lead (ring terminal) (20) in the inner surface of the lid (50), the current path of the electric current can be shortened and therefore the inner resistance is lowered and the output density is increased. Therefore, it is preferable.

In the invention, the upper surface of the upper current collecting plate (positive current collecting plate) and the inner surface of the lid are welded via a lead, however the structure of the lid and the shape of the lead are not limited.

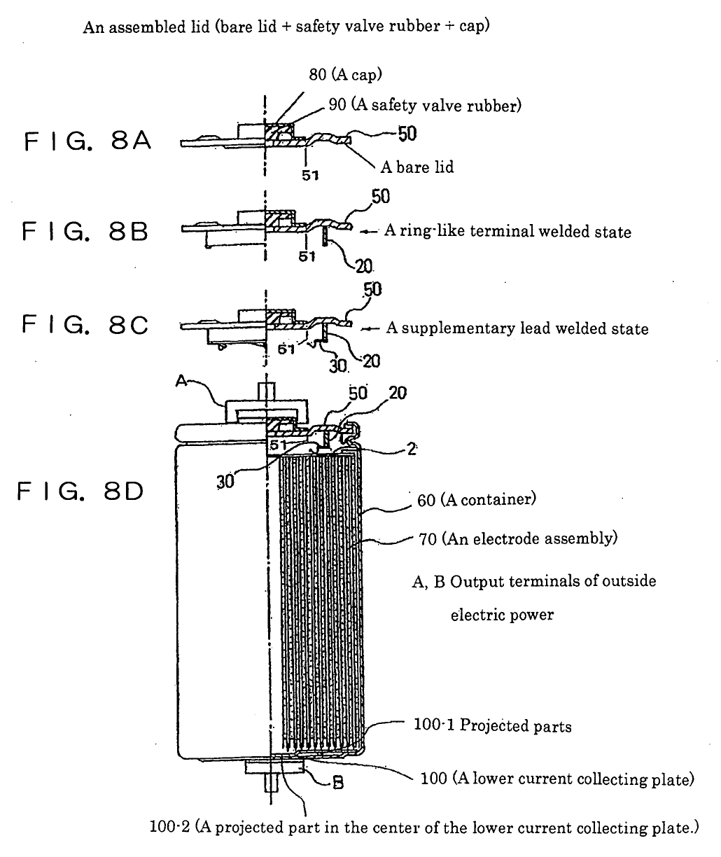

FIG. 8 shows an assembly drawing of, as an example, a sealed battery in which a ring-like main lead is welded through a supplementary lead.

In FIG. 8, (a) shows a cross-sectional view of one example of the structure of the lid (50) and the cap (80) is put on the upper part of the center of the bare lid via valve body (safety valve rubber) (90).

In FIG. 8, (b) shows the state that the main lead (ring terminal) (20) is previously welded with the lid part (50).

Further, in FIG. 8, (c) shows the state that the main lead (ring terminal) (20) and the supplementary lead (30) are previously welded with the lid part (50) shown in (b).

Further, in FIG. 8, (d) shows the state that the lid part (50) shown in (c) previously welded with the main lead (ring terminal) (20) and the supplementary lead (30) is welded with the upper current collecting plate (2) of the sealed battery.

In this case, in the invention, the welding points of the main lead (ring terminal) (20) in the inner surface of the lid (50) are preferably outside of the position (51) of the inner surface of the lid corresponding to the end part of the cap. Accordingly, in the case where the current leading-out contact point to the outside of the battery are outside of the end part of the cap in the upper surface of the lid, the current path of the electric current can be shortened and therefore the inner resistance is lowered and the output density can be increased.

Hereinafter, embodiments of the invention will be described while exemplifying a cylindrical nickel metal-hydride battery, however the invention should not be limited to these embodiments exemplified below.

### EXAMPLE 1

### Production of Positive Electrode Plate

An ammine complex was produced by adding ammonium sulfate and an aqueous sodium hydroxide solution to an aqueous solution containing nickel sulfate, zinc sulfate, and cobalt sulfate dissolved at a prescribed ratio. While the reaction system was fiercely stirred, sodium hydroxide was further dropwise added to control pH of the reaction system at 11 to 12 to synthesize spherical and high density nickel hydroxide particles to be a core layer mother material so as to be a ratio of nickel hydroxide:zinc hydroxide:cobalt hydroxide=88.45:5.12:1.1.

The high density nickel hydroxide particles were added to an aqueous alkaline solution adjusted at pH 11 to 13 with sodium hydroxide. While the solution was stirred, an aqueous solution containing prescribed concentrations of cobalt sulfate and ammonia was dropwise added. During the time, the aqueous sodium hydroxide solution was properly dropwise added to keep the pH of the reaction system at 11 to 12. The reaction system was kept at pH 11 to 12 for about 1 hour to form a surface layer containing a mixed hydroxide containing Co on the surfaces of the nickel hydroxide particles. The ratio of the surface layer of the mixed hydroxide is 4.0% by weight to the core layer mother particles (hereinafter, simply referred to as a core layer).

To a aqueous 30% by weight (10N) sodium hydroxide solution at 110° C., 50 g of nickel hydroxide particles having the surface layer containing the mixed hydroxide were added to a 30% by weight (10 N) aqueous sodium hydroxide solution and sufficiently stirred. Successively, K₂S₂O₈ in an excess amount to the equivalent of cobalt hydroxide contained in the surface layer was added to confirm evolution of oxygen gas from the particle surfaces. The active material particles were filtered and washed with water and dried.

An aqueous carboxymethyl cellulose (CMC) solution was added to the active material particles to give a paste containing the active material particles and CMC solute at 99.5:0.5 and a nickel porous body (Ni Celmet #8, manufactured by Sumitomo Electric Industries, Ltd.) with 450 g/m² was filled the paste. After that, the porous body was dried at 80° C. and then pressed in a prescribed thickness, successively coated with a polytetrafluoroethylene coating, and formed into a nickel positive electrode plate with a width of 47.5 mm (uncoated part 1 mm), a length of 1150 mm, and a capacity of 6500 mAh (6.5 Ah).

### (Production of Negative Electrode Plate)

A hydrogen-storage alloy powder having a AB₅ type rare earth-based composition; MmNi_{3.6}Co_{0.6}Al_{0.3}Mn_{0.5} (Mm means mish metal) with a particle size of 30 μm after hydrogen storage treatment was immersed in a 48% by weight aqueous NaOH solution to the relative density of 20° C. and immersed in the aqueous solution at 100° C. for 4 hours.

After that, the alloy powder-containing solution was pressure-filtered to separate the solution and the alloy and the same weight of pure water as the weight of the alloy was added and ultrasonic wave at 28 KHz was applied for 10 minutes. Thereafter, while the mixture being moderately stirred, pure water was injected from the lower part of the stirred layer to make wastewater flow out and remove a rare earth hydroxide parted from the alloy. After that, the alloy was washed with water until the pH was lowered to 10 or lower and then filtered under pressure. Successively, the allow was exposed to hot water at 80° C. to isolate hydrogen. The hot water was filtered under pressure and the alloy was again washed with water and cooled to 25° C. and under condition of stirring, 4% hydrogen peroxide was added in the same weight as that of the alloy to isolate hydrogen and thus obtain a hydrogen-storage alloy for electrodes.

The obtained alloy and styrene-butadiene copolymer were mixed at a ratio of 99.35:0.65 by weight on the basis of solid matter and dispersed in water to obtain a past, applied to a negative electrode substrate of punched steel plate obtained by plating iron with nickel, and dried at 80° C. and the resulting negative electrode substrate was pressed in a prescribed thickness to obtain a hydrogen-storage alloy negative electrode plate with a width of 47.5 mm, a length of 1175 mm, and a capacity of 11000 mAh (11.0 Ah). (Production of sealed nickel metal-hydride storage battery)

The above-mentioned negative electrode plate, a nonwoven fabric type separator of a sulfonated 120 μm-thick polypropylene, and the above-mentioned positive electrode plate were combined and rolled in a roll-like state to obtain an electrode assembly. A disc-like upper current collecting plate (positive current collecting plate) made of a nickel-plated steel plate with a diameter of 14.5 mm and a thickness of 0.4 mm and having a circular through hole in the center and 8 ridges of 0.5 mm (parts for biting the electrode substrate) (4 slits) as shown in FIG. 2A was welded with the end face of the positive electrode substrate projected out of one end face of the roll electrode assembly by resistance welding. Further, four projected parts (100-1) to be the welding points with the container bottom as shown in FIG. 4 were formed in a disc-like lower current collecting plate (negative current collecting plate) made of a nickel-plated steel plate with a diameter of 14.5 mm and a thickness of 0.4 mm and having a circular through hole in the center and 8 ridges with 0.5 mm (parts for biting the electrode substrate) (4 slits) as shown in FIG. 2A, outside of the position of the negative current collecting plate corresponding to immediately under the end part of the cap. The negative current collecting plate was joined to the end face of the negative electrode substrate projected out of the other side of the rolled type electrode assembly by resistance welding.

A cylindrical container having a bottom and made of a nickel-plated steel plate was prepared and the above-mentioned electrode assembly to which the current collecting plates were attached was housed in the container in a manner that the positive current collecting plate was set in the open side of the container and the negative current collecting plate was brought into contact with the bottom of the container and a prescribed amount of an electrolyte solution, which was an aqueous solution containing 6.8 N KOH and 0.8 N LiOH.

After the solution was poured, the output terminals for welding of a resistance welding apparatus were brought into contact with the positive current collecting plate and the bottom surface (negative electrode terminal) of the container and the electric current application conditions were set in the electric current application conditions of the same electric current for the same application time in the charging direction and the discharging direction. Practically, electric current was set to be 0.6 kA/Ah per Ah to the capacity (6.5 Ah) of the positive electrode plate and the application time was set 4.5 msec in the charging direction and 4.5 msec in the discharge direction and it was also made possible to carry out one cycle electric current application in which one cycle was alternating current pulse and alternating pulses of one cycle with rectangular waveform were applied. The electric current applied in such a manner performed welding of the lower surface of the negative current collecting plate and the inner surface of the container bottom at the four projected parts positioned at 9 mm from the center of the negative current collecting plate.

In this case, the welding points of the lower surface of the negative current collecting plate and the inner surface of the container bottom were at positions parted from the center by 62% in the length (radius: 14.5 mm) from the center to the outer circumference of the negative current collecting plate. In this case, the welding points of the lower surface of the negative current collecting plate (100) and the inner surface of the bottom of the container (60) were outside of the position (101) of the lower current collecting plate (100) corresponding to immediately under the end part of the cap (80).

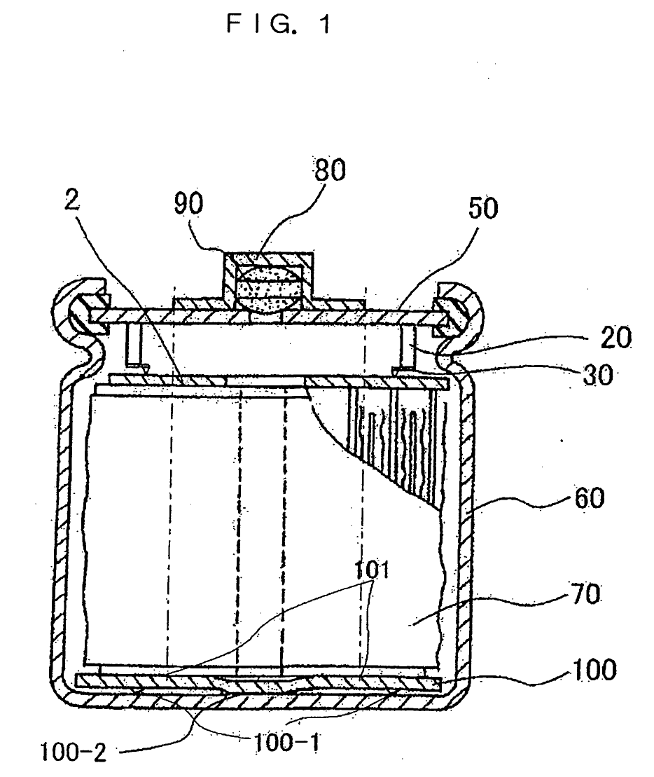

Thereafter, without applying electric current in the battery, an electrode rod for resistance welding was pushed to the upper surface of the negative current collecting plate and the outer surface of the container bottom, the projected part (100-2) formed in the center part of the lower surface of the negative current collecting plate and the inner surface of the container bottom were closely contacted and the projected part (100-2) was joined to the inner surface of the container bottom by resistance welding as shown in FIG. 1.

A ring-like main lead with an inner diameter of 20 mm produced by rolling a 0.6 mm-thick nickel plate with a width of 2.5 mm and a length of 66 mm and having 10 projected parts with a height of 0.5 mm in one long side and 4 projected part in the other long side and a supplementary lead having 4 projected parts to be welding points with the positive current collecting plate were made ready.

A disc-like lid having a circular through hole with a diameter of 0.8 mm in the center and made of a nickel-plated steel plate was made ready and the 10 projected parts of the main lead with a height of 0.5 mm were brought into contact with the inner surface side of the lid and the ring-like main lead was joined to the inner surface of the lid by resistance welding. Next, the supplementary lead was welded to the ring-like main lead. A rubber valve (gas discharge valve) and a cap-like terminal were attached to the outer surface of the lid. A ring-like gasket was attached to the lid in a manner that the gasket wraps the peripheral rim of the lid.

The radius of the lid was 14.5 mm and the radium of the cap was 6.5 mm and the caulked radius of the gasket was 12.5 mm.

The lid to which the main lead and the supplementary lead were attached was put on the electrode assembly in contact with the positive current collecting plate and the open end of the container was caulked and closed air-tightly and compacted to adjust the entire height of the battery.

The radium of the mine lead inner surface was set to be 10 mm and the distanced between the welding points (projected parts) of the supplementary lead with the upper current collecting plate and the inner surface of the main lead was set to be 1 mm. That is, the inner radius surrounded with the 4 projected parts was 9 mm and the welding points of the supplementary lead in the upper surface of the upper current collecting plate were at positions parted by 62% in the length from the center of the upper current collecting plate to the outer circumference (radius: 14.5 mm).

The output terminals for welding of a resistance welding apparatus were brought into contact with the cap 80 (the positive electrode terminal) and the bottom surface (negative electrode terminal) of the container 60 and the electric current application conditions were set in the electric current application conditions of the same electric current for the same application time in the charging direction and the discharging direction. Practically, electric current was set to be 0.6 kA/Ah per Ah (3.9 kA) to the capacity (6.5 Ah) of the positive electrode plate and the application time was set 4.5 msec in the charging direction and 4.5 msec in the discharge direction and it was also made possible to carry out two-cycle electric current application in which one cycle was alternating current pulse and alternating pulses of one cycle with rectangular waveform were applied. At that time, it was confirmed that no gas was evolved exceeding the valve opening pressure. In such a manner, the lid 50 and the positive current collecting plate 2 were connected by the ring-like main lead via the supplementary lead to produce a sealed nickel metal-hydride secondary battery as shown in FIG. 1.

Further, the weights of all of the batteries used in Examples and Comparative Examples of the invention were 176 g.

### (Measurement of Chemical Conversion, Inner Resistance, and Output Density)

Each sealed secondary battery was kept at 25° C. for 12 hours and charged with 1200 mAh at 130 mA (0.02 ItA) and successively charged at 650 mA (0.1 ItA) for 10 hours and then discharged at 1300 mA (0.2 ItA) to cut voltage 1 V. Further, each battery was charged at 650 mA (0.1 ItA) for 16 hours and discharged at 1300 mA (0.2 ItA) to cut voltage 1.0 V and the charging and discharging were defined as one cycle and 4-cycle charging/discharging were carried out. On completion of the 4^{th} cycle, the inner resistance was measured at 1 kHz alternating current.

The method of measuring output density was carried out in the following manner: that is, 10th-second voltage at the time when electric current was applied at 60 A for 12 seconds after charging for 5 hours at 650 mA (0.1 ItA) from the discharge end was defined as 10^{th}-second voltage at 60 A discharge: 10th-second voltage at the time when electric current was applied at 90 A for 12 seconds after charging electric capacity of the discharged extent at 6 A was defined as 10^{th}-second voltage at 90 A discharge: 10^{th}-second voltage at the time when electric current was applied at 120 A for 12 seconds after charging electric capacity of the discharged extent at 6 A was defined as 10^{th}-second voltage at 120 A discharge: 10^{th}-second voltage at the time when electric current was applied at 150 A for 12 seconds after charging electric capacity of the discharged extent at 6 A was defined as 10^{th}-second voltage at 150 A discharge: and 10^{th}-second voltage at the time when electric current was applied at 180 A for 12 seconds after charging electric capacity of the discharged extent at 6 A was defined as 10^{th}-second voltage at 180 A discharge.

These respective 10^{th} voltages were linearly approximated by minimum division method of the current values and the voltage values and the voltage at the current value of 0 A was defined as value E0 and the inclination was defined as RDC. The output density of each battery at 25° C. and 0.8 V cut was calculated according to the following equation: Output density (W/kg)=(E0−0.8)÷RDC×0.8÷battery weight (kg).

### EXAMPLE 2

A sealed battery as shown in FIG. 1 was obtained in the same manner as Example 1, except that 8 projected parts to be the welding points with the container bottom were formed at positions of 9 mm distance from the center of the negative current collecting plate.

### EXAMPLE 3

A sealed battery as shown in FIG. 1 was obtained in the same manner as Example 1, except that 16 projected parts to be the welding points with the container bottom were formed at positions of 9 mm distance from the center of the negative current collecting plate.

### COMPARATIVE EXAMPLE 1

A sealed battery as shown in FIG. 1 was obtained in the same manner as Example 1, except that 4 projected parts at positions of 9 mm distance from the center of the negative current collecting plate were not welded. (That is, the lower surface of the negative current collecting plate and the inner surface of the container bottom were welded only at one point in the center.)

### EXAMPLE 4

A sealed battery as shown in FIG. 1 was obtained in the same manner as Example 1, except that 4 projected parts to be the welding points with the container bottom were formed at positions of 9 mm distance from the center of a negative current collecting plate on the negative current collecting plate, which was a disk-like plate with a radius of 14.5 mm made of a nickel-plated steel plate with a thickness of 0.4 mm and having a circular through hole in the center and 16 ridges with 0.5 mm (parts for biting the electrode substrate) (8 slits) as shown in FIG. 3B.

### EXAMPLE 5

A sealed battery as shown in FIG. 1 was obtained in the same manner as Example 4, except that 8 projected parts (100-1) to be the welding points with the container bottom were formed at positions of 9 mm distance from the center of the negative current collecting plate as shown in FIG. 5.

### EXAMPLE 6

A sealed battery as shown in FIG. 4 was obtained in the same manner as Example 4, except that 16 projected parts (100-1) to be the welding points with the container bottom were formed at positions of 9 mm distance from the center of the negative current collecting plate as shown in FIG. 6.

### COMPARATIVE EXAMPLE 2

A sealed battery as shown in FIG. 1 was obtained in the same manner as Example 4, except that 20 projected parts to be the welding points with the container bottom were formed at positions of 9 mm distance from the center of the negative current collecting plate.

### COMPARATIVE EXAMPLE 3

A sealed battery as shown in FIG. 1 was obtained in the same manner as Example 4, except that 2 projected parts (100-1) to be the welding points with the container bottom were formed at positions of 9 mm distance from the center of the negative current collecting plate as shown in FIG. 7.

### COMPARATIVE EXAMPLE 4

A sealed battery as shown in FIG. 1 was obtained in the same manner as Example 4, except that 4 projected parts at positions of 9 mm distance from the center of the negative current collecting plate were not welded. (That is, the lower surface of the negative current collecting plate and the inner surface of the container bottom were welded only at one point in the center.)

The sealed batteries obtained in Examples 2 to 6 and Comparative Examples 1 to 4 were converted in the same conditions as described in Example 1 and subjected to the measurement of inner resistance and output density. The results of the measurement of inner resistance and output density are shown in Table 1.

TABLE 1

| | Number of | | | | | | | |
|---|---|---|---|---|---|---|---|---|
| | ridges | | | Points in lower current collecting | | | | |
| | (number of | | | plate | | | | |
| | slits, | | Welding points in | Position | | Welding points | Inner | Output |
| | number of | | container bottom | from the | Ratio to | of lower current | resistance | density |
| Classification | ridges) | | (number of points) | center | radius | collecting plate | (mΩ) | (W/kg) |
| Example 1 | 4 | 8 | One point in the | 9 | 62% | Outside of the | 0.88 | 1560 |
| | | | center + 4 points | | | end part of the | | |
| | | | outside of the end | | | cap | | |
| | | | part of the cap | | | | | |
| Example 2 | 4 | 8 | One point in the | 9 | 62% | Outside of the | 0.86 | 1620 |
| | | | center + 8 points | | | end part of the | | |
| | | | outside of the end | | | cap | | |
| | | | part of the cap | | | | | |
| Example 3 | 4 | 8 | One point in the | 9 | 62% | Outside of the | 0.84 | 1650 |
| | | | center + 16 points | | | end part of the | | |
| | | | outside of the end | | | cap | | |
| | | | part of the cap | | | | | |
| Comparative | 4 | 8 | One point in the | 9 | 62% | Outside of the | 0.97 | 1450 |
| Example 1 | | | center | | | end part of the | | |
| | | | | | | cap | | |
| Example 4 | 8 | 16 | One point in the | 9 | 62% | Outside of the | 0.84 | 1650 |
| | | | center + 4 points | | | end part of the | | |
| | | | outside of the end | | | cap | | |
| | | | part of the cap | | | | | |
| Example 5 | 8 | 16 | One point in the | 9 | 62% | Outside of the | 0.80 | 1680 |
| | | | center + 8 points | | | end part of the | | |
| | | | outside of the end | | | cap | | |
| | | | part of the cap | | | | | |
| Example 6 | 8 | 16 | One point in the | 9 | 62% | Outside of the | 0.80 | 1710 |
| | | | center + 16 points | | | end part of the | | |
| | | | outside of the end | | | cap | | |
| | | | part of the cap | | | | | |
| Comparative | 8 | 16 | One point in the | 9 | 62% | Outside of the | 0.92 | 1530 |
| Example 2 | | | center + 20 points | | | end part of the | | |
| | | | outside of the end | | | cap | | |
| | | | part of the cap | | | | | |
| Comparative | 8 | 16 | One point in the | 9 | 62% | Outside of the | 0.92 | 1540 |
| Example 3 | | | center + 2 points | | | end part of the | | |
| | | | outside of the end | | | cap | | |
| | | | part of the cap | | | | | |
| Comparative | 8 | 16 | One point in the | 9 | 62% | Outside of the | 0.92 | 1520 |
| Example 4 | | | center | | | end part of the | | |
| | | | | | | cap | | |

As shown in Table 1, it was found that the inner resistance was lowered and the output density was improved in the case of the sealed batteries of Examples 1 to 6 in which the welding points were formed at positions parted at 62% from the center of the negative current collecting plate in the length from the center to the outer circumference of the negative current collecting plate as compared with the case of the sealed batteries of Comparative Examples 1 and 4 in which the lower surface of the negative current collecting plate and the inner surface of the container bottom were welded at only one point in the center.

All of the batteries showed output density exceeding 1400 W/kg.

The output of 1400 W/kg means that the batteries had capability of keeping no lower than 1 V/cell at a normal temperature even if discharging at 200 A (equivalent of 30 ItA rate) at the time of assist of a hybrid type electric vehicle (HEV). Therefore, the nickel metal-hydride battery having an output density of 1400 W/kg or higher can be expected to have 1 V/cell as the lower limit of voltage control for preventing super-discharge and accordingly in the case the upper limit of the discharging rate is set to be 30 ItA, the super-discharge can be prevented in any discharge pattern and thus the battery is preferable.

Since the batteries of Examples 4 to 6 having a larger number of the ridges (biting parts to the electrode substrate), that is 16, have a higher density of the welding points of the negative current collecting plate and the negative electrode substrate than the batteries of Example 1 to 3 and are provided with higher current collecting function of the negative electrode plate and thus the inner resistance is lowered and the output density is improved.

Further, it was found that the number of the welding points was increased in a range from 4 to 16, the inner resistance was lowered and the output density was improved.

In the case of the sealed battery of Comparative Example 2 having an extremely large number of the welding points, 20, in the lower surface of the negative current collecting plate and the inner surface of the container bottom and in the case of the sealed battery of Comparative Example 3 having an extremely small number of the welding points, 2, the effect of lowering the inner resistance and improving the output density was low.

It is supposedly attributed to that since the welding current of the welding points is required to be a certain electric current, if the welding points exceed 18 points, the electric current to flow the battery has to be increased and therefore it exceeds the electrostatic capacity of the electrode assembly and gas is possibly evolved due to the decomposition of the electrolyte solution to cause leakage of the solution at the time electric application. Accordingly, if the maximum electric current and the electric power application time are suppressed, no sufficient current necessary for the welding at the respective welding points can be obtained and welding failure due to insufficient electric current occurs to result in high resistance of the welding points. On the other hand, in the case of two points, although the welding of the welding points can be carried out reliably, since the welding points are points with relatively high resistance, the resistance is supposed to be high as a whole due to insufficient number of the contact points.

### COMPARATIVE EXAMPLE 5

A sealed battery as shown in FIG. 1 was obtained in the same manner as Example 4, except that 8 projected parts to be welding points of the container bottom at positions of 4 mm distance from the center were formed.

In this case, the welding points of the lower surface of the negative current collecting plate and the inner surface of the container bottom were at positions parted from the center by 28% in the length (radius: 14.5 mm) from the center to the outer circumference of the negative current collecting plate.

### COMPARATIVE EXAMPLE 6

A sealed battery as shown in FIG. 1 was obtained in the same manner as Example 4, except that 8 projected parts to be welding points of the container bottom at positions of 5 mm distance from the center were formed.

In this case, the welding points of the lower surface of the negative current collecting plate and the inner surface of the container bottom were at positions parted from the center by 34% in the length (radius: 14.5 mm) from the center to the outer circumference of the negative current collecting plate.

### COMPARATIVE EXAMPLE 7

A sealed battery as shown in FIG. 1 was obtained in the same manner as Example 4, except that 8 projected parts to be welding points of the container bottom at positions of 6 mm distance from the center were formed.

In this case, the welding points of the lower surface of the negative current collecting plate and the inner surface of the container bottom were at positions parted from the center by 41% in the length (radius: 14.5 mm) from the center to the outer circumference of the negative current collecting plate.

### EXAMPLE 7

A sealed battery as shown in FIG. 1 was obtained in the same manner as Example 4, except that 16 projected parts to be welding points of the container bottom at positions of 7 mm distance from the center were formed.

In this case, the welding points of the lower surface of the negative current collecting plate and the inner surface of the container bottom were at positions parted from the center by 48% in the length (radius: 14.5 mm) from the center to the outer circumference of the negative current collecting plate.

### EXAMPLE 8

A sealed battery as shown in FIG. 1 was obtained in the same manner as Example 4, except that 16 projected parts to be welding points of the container bottom at positions of 9 mm distance from the center were formed.

In this case, the welding points of the lower surface of the negative current collecting plate and the inner surface of the container bottom were at positions parted from the center by 62% in the length (radius: 14.5 mm) from the center to the outer circumference of the negative current collecting plate.

### EXAMPLE 9

A sealed battery as shown in FIG. 1 was obtained in the same manner as Example 4, except that 16 projected parts to be welding points of the container bottom at positions of 10 mm distance from the center were formed.

In this case, the welding points of the lower surface of the negative current collecting plate and the inner surface of the container bottom were at positions parted from the center by 69% in the length (radius: 14.5 mm) from the center to the outer circumference of the negative current collecting plate.

### EXAMPLE 10

A sealed battery as shown in FIG. 1 was obtained in the same manner as Example 4, except that 16 projected parts to be welding points of the container bottom at positions of 11 mm distance from the center were formed.

In this case, the welding points of the lower surface of the negative current collecting plate and the inner surface of the container bottom were at positions parted from the center by 76% in the length (radius: 14.5 mm) from the center to the outer circumference of the negative current collecting plate.

### EXAMPLE 11

A sealed battery as shown in FIG. 1 was obtained in the same manner as Example 4, except that 16 projected parts to be welding points of the container bottom at positions of 12 mm distance from the center were formed.

In this case, the welding points of the lower surface of the negative current collecting plate and the inner surface of the container bottom were at positions parted from the center by 83% in the length (radius: 14.5 mm) from the center to the outer circumference of the negative current collecting plate.

### EXAMPLE 12

A sealed battery as shown in FIG. 1 was obtained in the same manner as Example 4, except that 16 projected parts to be welding points of the container bottom at positions of 13 mm distance from the center were formed.

In this case, the welding points of the lower surface of the negative current collecting plate and the inner surface of the container bottom were at positions parted from the center by 90% in the length (radius: 14.5 mm) from the center to the outer circumference of the negative current collecting plate.

### EXAMPLE 13

A sealed battery as shown in FIG. 1 was obtained in the same manner as Example 4, except that 16 projected parts to be welding points of the container bottom at positions of 13.5 mm distance from the center were formed.

In this case, the welding points of the lower surface of the negative current collecting plate and the inner surface of the container bottom were at positions parted from the center by 93% in the length (radius: 14.5 mm) from the center to the outer circumference of the negative current collecting plate.

The sealed batteries obtained in Comparative Examples 5 to 7 and Examples 7 to 13 were converted in the same conditions as described in Example 1 and subjected to the measurement of inner resistance and output density. The results of the measurement of inner resistance and output density are shown in Table 2.

TABLE 2

| | | | | Lower current collecting plate | | | | |
|---|---|---|---|---|---|---|---|---|
| | Number of | | | position | | | | |
| | ridges | | | | | Welding | | |
| | (number of | | | Position | | points of | | |
| | slits, | | Welding points in | from | Ratio | lower current | Inner | Output |
| | number of | | container bottom | the | to | collecting | resistance | density |
| Classification | ridges) | | (number of points) | center | radius | plate | (mΩ) | (W/kg) |
| Comparative | 8 | 16 | One point in the | 4 | 28% | Outside of the | 0.95 | 1480 |
| Example 5 | | | center + 8 points | | | end part of | | |
| | | | outside of the end | | | the cap | | |
| | | | part of the cap | | | | | |
| Comparative | 8 | 16 | One point in the | 5 | 34% | Outside of the | 0.93 | 1510 |
| Example 6 | | | center + 8 points | | | end part of | | |
| | | | outside of the end | | | the cap | | |
| | | | part of the cap | | | | | |
| Comparative | 8 | 16 | One point in the | 6 | 41% | Outside of the | 0.92 | 1520 |
| Example 7 | | | center + 8 points | | | end part of | | |
| | | | outside of the end | | | the cap | | |
| | | | part of the cap | | | | | |
| Example 7 | 8 | 16 | One point in the | 7 | 48% | Outside of the | 0.8 | 1700 |
| | | | center + 16 points | | | end part of | | |
| | | | outside of the end | | | the cap | | |
| | | | part of the cap | | | | | |
| Example 8 | 8 | 16 | One point in the | 9 | 62% | Outside of the | 0.8 | 1710 |
| | | | center + 16 points | | | end part of | | |
| | | | outside of the end | | | the cap | | |
| | | | part of the cap | | | | | |
| Example 9 | 8 | 16 | One point in the | 10 | 69% | Outside of the | 0.8 | 1710 |
| | | | center + 16 points | | | end part of | | |
| | | | outside of the end | | | the cap | | |
| | | | part of the cap | | | | | |
| Example 10 | 8 | 16 | One point in the | 11 | 76% | Outside of the | 0.8 | 1700 |
| | | | center + 16 points | | | end part of | | |
| | | | outside of the end | | | the cap | | |
| | | | part of the cap | | | | | |
| Example 11 | 8 | 16 | One point in the | 12 | 83% | Outside of the | 0.81 | 1670 |
| | | | center + 16 points | | | end part of | | |
| | | | outside of the end | | | the cap | | |
| | | | part of the cap | | | | | |
| Example 12 | 8 | 16 | One point in the | 13 | 90% | Outside of the | 0.85 | 1660 |
| | | | center + 16 points | | | end part of | | |
| | | | outside of the end | | | the cap | | |
| | | | part of the cap | | | | | |
| Example 13 | 8 | 16 | One point in the | 13.5 | 93% | Outside of the | 0.86 | 1650 |
| | | | center + 16 points | | | end part of | | |
| | | | outside of the end | | | the cap | | |
| | | | part of the cap | | | | | |

As shown in Table 2, it was found that the inner resistance was lowered and the output density was improved in the case of the sealed batteries of Examples 7 to 13 in which 16 welding points were formed at positions within a range between a concentric circle parted from the center by 48% and a concentric circle parted from the center by 93% in the length from the center to the outer circumference of the lower current collecting plate as compared with the case of the sealed batteries of Comparative Examples 5 to 7 in which 8 welding points (welding at 16 points was impossible) were formed at positions within a range less than 48% in the length from the center to the outer circumference of the lower current collecting plate.

In particular, in the case the welding points were formed at positions within a range between a concentric circle parted from the center by 48% and a concentric circle parted from the center by 76% in the length from the center to the outer circumference of the lower current collecting plate, just like the case of Examples 7 to 10, the effect of lowering the inner resistance and improving the output density is significant.

In the sealed battery of Comparative Examples 5 to 7, 8 welding points of the lower surface of the negative current collecting plate and the inner surface of the container bottom were in a range inner side than the position of the negative current collecting plate corresponding to immediately under the end part of the cap and thus the electric current path was long and accordingly, it was supposed that the inner resistance was increased.

The sealed cylindrical nickel metal-hydride secondary batteries were employed for Examples within the scope of the invention, the invention should not be limited to the nickel metal-hydride batteries and may be applicable for secondary batteries such as nickel-cadmium batteries, lithium ion batteries, lithium-polymer batteries (including gel), and control valve type lead-acid batteries and sealed primary and secondary batteries such as alkaline primary batteries and lithium coin type batteries.

Further, the lead and the cell-to-cell connector as constituent components are not limited to the ring-like ones as shown in Examples but may have other shapes.

Examples are described while exemplifying the welding carried out in the same conditions for the in-battery connection and inter-battery connection, however the invention include other proper conditions beside the above-mentioned welding conditions for Examples if these conditions are not departed from the scope of the invention.

Further, shapes and materials of the positive electrode plate, the positive current collecting plate, the separator, the negative electrode plate, the negative current collecting plate employed for Examples are not limited in the invention.

### INDUSTRIAL APPLICABILITY

A sealed battery of the invention and an assembled battery composed of a plurality of such sealed battery have a low resistance and high output and thus are useful for batteries of electric vehicles and electric tools.

1. A sealed battery obtained by housing an electrode assembly comprising a positive electrode plate and a negative electrode plate in a container, arranging an upper current collecting plate on said electrode assembly, welding the upper surface of said upper current collecting plate electrically connected with one of the electrodes of said electrode assembly with the inner surface of a lid through a lead, using a safety valve formed by putting a cap on the center upper part of a bare lid through a valve body as said lid, arranging a lower current collecting plate under said electrode assembly, and welding the lower surface of said lower current collecting plate electrically connected with the other electrode of said electrode assembly with the inner surface of the container bottom; wherein welding portions of the lower surface of said lower current collecting plate and the inner surface of said container bottom are at least outside of positions of said lower current collecting plate corresponding to immediately under the end part of said cap.

2. The sealed battery according to claim 1, wherein the welding portions of the lower surface of said lower current collecting plate and the inner surface of said container bottom are at one point of the center part of said lower current collecting plate and 4 to 16 points outside of positions of said lower current collecting plate corresponding to immediately under the end part of said cap.

3. A sealed battery obtained by housing an electrode assembly comprising a positive electrode plate and a negative electrode plate in a container, arranging an upper current collecting plate on said electrode assembly, welding the upper surface of said upper current collecting plate electrically connected with one of the electrodes of said electrode assembly with the inner surface of a lid through a lead, arranging a lower current collecting plate under said electrode assembly, and welding the lower surface of said lower current collecting plate electrically connected with the other electrode of said electrode assembly with the inner surface of the container bottom; wherein welding portions of the lower surface of said lower current collecting plate and the inner surface of said container bottom are within a range between a concentric circle parted from the center by 48% and a concentric circle parted from the center by 93% in the length from the center to the outer circumference of said lower current collecting plate.

4. The sealed battery according to claim 3, wherein the welding portions of the lower surface of said lower current collecting plate and the inner surface of said container bottom are at least within a range between a concentric circle parted from the center by 48% and a concentric circle parted from the center by 76% in the length from the center to the outer circumference of said lower current collecting plate.

5. The sealed battery according to claim 3, wherein the welding portions of the lower surface of said lower current collecting plate and the inner surface of said container bottom are at one point of the center part of said lower current collecting plate and 4 to 16 points within a range between a concentric circle parted from the center by 48% and a concentric circle parted from the center by 93% in the length from the center to the outer circumference of said lower current collecting plate.

6. The sealed battery according to claim 4, wherein the welding portions of the lower surface of said lower current collecting plate and the inner surface of said container bottom are at one point of the center part of said lower current collecting plate and 4 to 16 points within a range between a concentric circle parted from the center by 48% and a concentric circle parted from the center by 76% in the length from the center to the outer circumference of said lower current collecting plate.

7. The sealed battery according to claim 3, wherein the welding points of the lead in the upper surface of said upper current collecting plate is within a range between a concentric circle parted from the center by 48% and a concentric circle parted from the center by 93% in the length from the center to the outer circumference of said upper current collecting plate.

8. A method for producing a sealed battery as described in claim 1 comprising a first step of welding at welding points outside of positions of said lower current collecting plate corresponding to immediately under the end part of said cap and a second step of welding at one point in the center part of said lower current collecting plate.

9. The method for producing a sealed battery according to claim 8, wherein a welding method of the first step of welding at welding points outside of positions of said lower current collecting plate corresponding to immediately under the end part of said cap is performed by applying alternating current pulses in sets of charging and discharging between said upper current collecting plate (an outside positive electrode terminal before assembly of the battery) and the negative electrode terminal using an outside electric power after an electrolyte solution is injected to said electrode assembly.

10. The method for producing a sealed battery according to claim 8, wherein a welding method of the second step of welding at one point in the center part of said lower current collecting plate is performed by pressing electrode rods for resistance welding to the upper surface of said lower current collecting plate and the outer surface of said container bottom and by carrying out resistance welding of the lower surface of said lower current collecting plate and the inner surface of said container bottom.

11. A method for producing a sealed battery as described in claim 3 comprising a first step of welding at welding points within a range between a concentric circle parted from the center by 48% and a concentric circle parted from the center by 93% in the length from the center to the outer circumference of said lower current collecting plate and a second step of welding at one point in the center part of said lower current collecting plate.

12. The method for producing a sealed battery according to claim 11, wherein a welding method of the first step of welding at welding points within a range between a concentric circle parted from the center by 48% and a concentric circle parted from the center by 93% in the length from the center to the outer circumference of said lower current collecting plate is performed by applying alternating current pulses in sets of charging and discharging between said upper current collecting plate (an outside positive electrode terminal before assembly of the battery) and the negative electrode terminal using an outside electric power after an electrolyte solution is injected to said electrode assembly.

13. The method for producing a sealed battery according to claim 11, wherein a welding method of the second step of welding at one point in the center part of said lower current collecting plate is performed by pressing electrode rods for resistance welding to the upper surface of said lower current collecting plate and the outer surface of said container bottom and by carrying out resistance welding of the lower surface of said lower current collecting plate and the inner surface of said container bottom.

14. An assembled battery comprising a plurality of sealed batteries as described in claim 1.

15. An assembled battery comprising a plurality of sealed batteries as described claim 7.

16. The assembled battery according to claim 14, wherein the upper surface of the lid of one sealed battery and the outer surface of the container bottom of another sealed battery are connected through a cell-to-cell connector and the welding points of said cell-to-cell connector and the upper surface of said lid are outside of positions of the end part of the cap and the welding points of said cell-to-cell connector and the outer surface of said container bottom are outside of the positions of the outer surface of said container bottom corresponding to immediately above the end part of said cap.

17. The assembled battery according to claim 16, wherein the welding points of said cell-to-cell connector and the upper surface of said lid are adjusted to be coincident with the welding points of said lead in the inner surface of said lid in a range outside of the end part of said cap.
